(19) United States
(12) Patent Application Publication
(10) Pub. No.: US 2009/0271547 A1
(43) Pub. Date: Oct. 29, 2009

(54) Target Discovery and Virtual Device Access Control based on Username

(76) Inventors: Anuradha Goel, (US); Arvind Jain, (US)

Correspondence Address: ANURADHA GOEL, 850 HARBINS COVE DRIVE, LILBURN, GA, 30047, US

(21) Appl. No.: 12/427,726

(22) Filed: Apr. 21, 2009

Related U.S. Application Data
(60) Provisional application No. 61/048,458, filed on Apr. 28, 2008.

(51) Int. Cl. G06F 13/42; G06F 12/08

(52) U.S. Cl. 710/105; 711/6; 711/E12.016

(57) ABSTRACT

This invention is for discovery of a target such as iSCSI and virtual device access control based on a username and its synonyms. Since the same username can be entered from any initiator, the target discovery and virtual device access control will work from any initiator. In other words, this new method will be user-specific instead of being initiator-specific.

### CROSS-REFERENCE TO RELATED APPLICATIONS:

This application claims an invention which was disclosed in Provisional Application No. 61/048,458, filed Apr. 28, 2008, entitled “iSCSI Target Discovery based on a Username.” The benefit under 35 U.S.C §119(e) of the U.S. provisional application is fully claimed, and the aforementioned application is hereby incorporated herein by reference.

### BACKGROUND OF THE INVENTION

1. Field of the Invention

The present invention generally relates to storage systems. More specifically, the present invention pertains to storage target discovery and virtual device access control based on a username.

At present, targets such as iSCSI are discovered based on the initiator name. The management layer on the target keeps an ACL (Access Control List) table. The columns of this table contain the initiator name, target name, virtual device ID, permission, etc. When an initiator performs a target discovery, the management software searches this ACL table based on the initiator name and sends back the list of valid target name(s). An iSNS (Internet Storage Name Service) based approach for the target discovery also relies on the initiator name.

A method is required to perform the target discovery and virtual device access control even if the initiator name changes. One example of such a case is when the same iSCSI target is used to backup and restore from more than one host in an environment where the host name (initiator name) is not known to the target in advance.

The present invention accomplishes this by using the username instead of the initiator name to perform the target discovery and virtual device access control.

### BRIEF SUMMARY OF THE INVENTION

At present, the discovery of the storage target such as iSCSI is based on the initiator name. This methodology works fine when the association between the target and the initiator name remains static. However, this does not work if the initiator name is dynamic.

The present invention utilizes a username entered by the user for the target discovery and virtual device access control. The username can be entered by the user during target discovery and target logon, such as username entered during CHAP (Challenge Handshake Authentication Protocol). Since the same username can be entered from any initiator, the target discovery and virtual device access control will work from any initiator. In other words, this new method will be user-specific instead of being initiator-specific.

### BRIEF DESCRIPTION OF THE DRAWING

Further features and benefits of the present invention will be apparent from a detailed description of the invention with the following drawing:

FIG. 1 is a table describing how usernames can be used for target discovery and virtual device access control.

### DETAILED DESCRIPTION OF THE INVENTION

The proposed invention utilizes a username entered by the user for the target discovery and virtual device access control. The username can be entered by the user during target discovery and target logon, such as username entered during CHAP (Challenge Handshake Authentication Protocol).

This invention will allow us to do two things:

1. Target discovery based on username

2. Access control of a virtual device based on username

To explain this method, let us take an example.

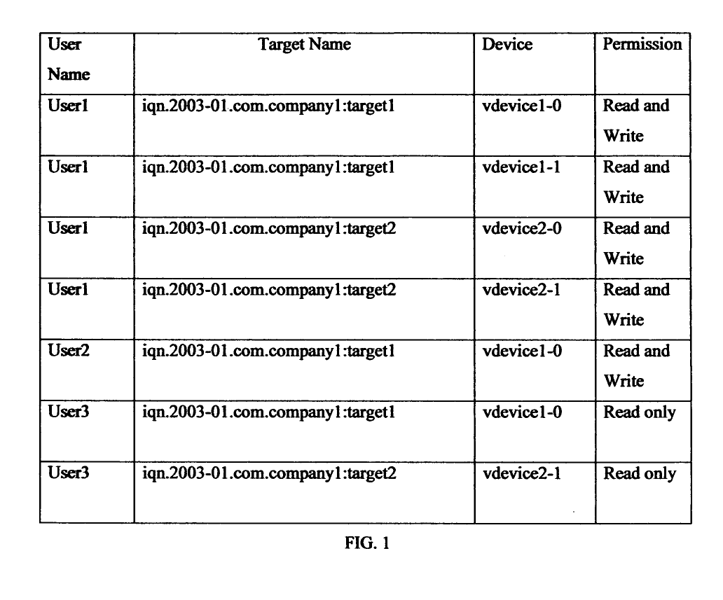

Using the proposed method for target discovery and virtual device control, the management layer of the target will keep an ACL (Access Control List) table as shown in FIG. 1. The target names in the FIG. 1 are iSCSI protocol-specific. However, similar methodology can be applied to other storage protocols as well.

With an ACL table as shown on FIG. 1, the following will occur:

1. When User1 performs the target discovery, the following targets will be reported:

iqn.2003-01.com.company1:target1

iqn.2003-01.com.company1:target2

When User1 logs on to the targets, he/she will have access to the following devices with the following permissions:

vdevice1-1—read and write access

vdevice1-1—read and write access

vdevice2-0—read and write access

vdevice2-1—read and write access

2. When User2 performs the target discovery, the following targets will be reported:

iqn.2003-01.com.company1:target1

When User2 logs on to the target, he/she will have access to the following devices with the following permissions:

vdevice1-0—read and write access

3. When User3 performs the target discovery, the following targets will be reported:

iqn.2003-01.com.company1:target1

iqn.2003-01.com.company1:target2

When User3 logs on to the targets, he/she will have access to the following devices with the following permissions:

vdevice1-0—read only access

vdevice2-1—read only access

In the above example, User1 can be seen as the owner of the following targets:

iqn.2003-01.com.company1:target1 and

iqn.200301.com.company1:target2

along with the following associated virtual devices:

vdevice1-0,

vdevice1-1,

vdevice2-0 and

vdevice2-1.

User1 can give access to the above resources to User2 and User3 as necessary.

This is an example only. The order and extent of access (permission) can be changed by the implementation of this invention. So the invention is not limited to the example above but embodies any combination of user or users using the claim herein. Similar methodology can be used with iSNS and other Storage Name Server services.

This invention allows the target to de-couple the discovery and ACL from the initiator name. The discovery and ACL can be controlled using the username only.

1. The patent claims target discovery based on a username and its synonyms (includes but not limited to username, user ID, account name, account number, customer name, customer number, operator name, and operator ID).

2. The patent claims virtual device access control based on a username and its synonyms (includes but not limited to username, user ID, account name, account number, customer name, customer number, operator name, and operator ID).
